(19) United States
(12) Patent Application Publication
(10) Pub. No.: US 2002/0084617 A1
(43) Pub. Date: Jul. 4, 2002

(54) Ambulation device

(76) Inventor: Michael J. Torsiello, Franklin Lakes, NJ (US)

Correspondence Address: Alfred C. Hill, 9 Shirley Terrace, Kinnelon, NJ, 07405, US

(21) Appl. No.: 10/072,062

(22) Filed: Feb. 6, 2002

Related U.S. Application Data
(63) Continuation-in-part of application No. 09/442,660, filed on Nov. 18, 1999.

(51) Int. Cl. B62M 1/14

(52) U.S. Cl. 280/250.1; 280/648

(57) ABSTRACT

An ambulation device for physically challenged persons comprising an ambulatory chair movable by feet of an occupant of the ambulatory chair; a rolling tripod walker having three wheels and a connection arrangement to selectively connect the ambulatory chair to the tripod walker to provide an integral unit and to selectively disconnect the ambulatory chair from the tripod walker to enable separate and independent use of the ambulatory chair and the tripod walker.

### CROSS-REFERENCES TO RELATED APPLICATIONS

The present application is a continuation-in-part application of co-pending application Ser. No. 09/442,660, filed Nov. 18, 1999, now abandoned.

### BACKGROUND OF THE INVENTION

The present invention relates to an ambulation device for physically challenged persons and more particularly to a combined ambulatory chair and tripod walker that may be provided as an integral unit and to be selectively disconnectable so that the chair and the walker can be separately and independently used by the physically challenged person.

The phrase “physically challenged person” refers to those persons that have difficulty in walking, such as institutionalized elderly, assisted living persons, partially disabled persons, home care persons and those persons generally not able to easily walk.

Previously known ambulation devices have included devices, such as walkers and ambulatory chairs, that have a relatively high center of gravity and are easily tipped if the person becomes unsteady in its use and, in particular, if the persons goes from one surface to another that may catch the wheels of the device thereby causing the tipping of this device and resulting in injury to the person using the device.

U.S. Pat. No. 3,999,778 cited in application Ser. No. 09/442,660 discloses an early form of a combined wheelchair and a tripod walker having only one wheel. The connection between the chair and the walker is complicated and would be difficult to easily separate the chair and the walker for independent use. Also, the walker of this patent is not a rolling walker having three wheels.

### SUMMARY THE INVENTION

An object of the present invention is to provide an ambulation device for physically challenged persons that have a lower center of gravity and provides more safety than has a lower center of gravity and provides more safety than the previously known ambulation devices and provides a source of physical therapy.

Another object of the present invention is to provide an ambulation device providing the occupant of the device with safety, independence, comfort, physical activity and therapy, containment without restraint and provides the patient with a number of functional and ergonomically designed accessories and attachments for the betterment of their quality of life.

A feature of the present invention is the provision of an ambulation device for physically challenged persons comprising an ambulatory chair movable by feet of an occupant of the ambulatory chair; a rolling tripod walker having three wheels; and connection means to selectively connect the ambulatory chair to the tripod walker to provide an integral unit and to selectively disconnect the ambulatory chair from the tripod walker to enable separate and independent use of the ambulatory chair and tripod walker by the occupant.

### BRIEF DESCRIPTION OF THE DRAWING

Above mentioned and other features and objects of the present invention will become more apparent by reference to the following description taken in conjunction with the accompanying drawing, in which:

FIG. 1 is a perspective view of the integral unit of an ambulatory chair and tripod walker in accordance with the principles of the present invention;

FIG. 2 is a front view of the ambulatory chair of FIG. 1;

FIG. 3 is a side view of the ambulatory chair of FIG. 2 in the position assumed when the occupant is seated in the chair;

FIG. 4 is a side view of the ambulatory chair of FIG. 1 in the position assumed when the occupant is no longer sitting in the seat but rather is standing;

FIG. 5 is a side view of the tripod walker of FIG. 1 in accordance with the principles of the present invention;

FIG. 6 is a detailed cross-sectional view of the hydraulic system employed in the ambulatory chair of FIGS. 1-4 in the unlocked position when the occupant is sitting in the seat of the chair;

FIG. 7 is a detailed cross-sectional view of the hydraulic system in the ambulatory chair of FIGS. 1-4 in the locked position when the occupant is standing; and

FIG. 8 is a cross-sectional view taken along line 8-8 of FIG. 7.

### DESCRIPTION OF THE PREFERRED EMBODIMENTS

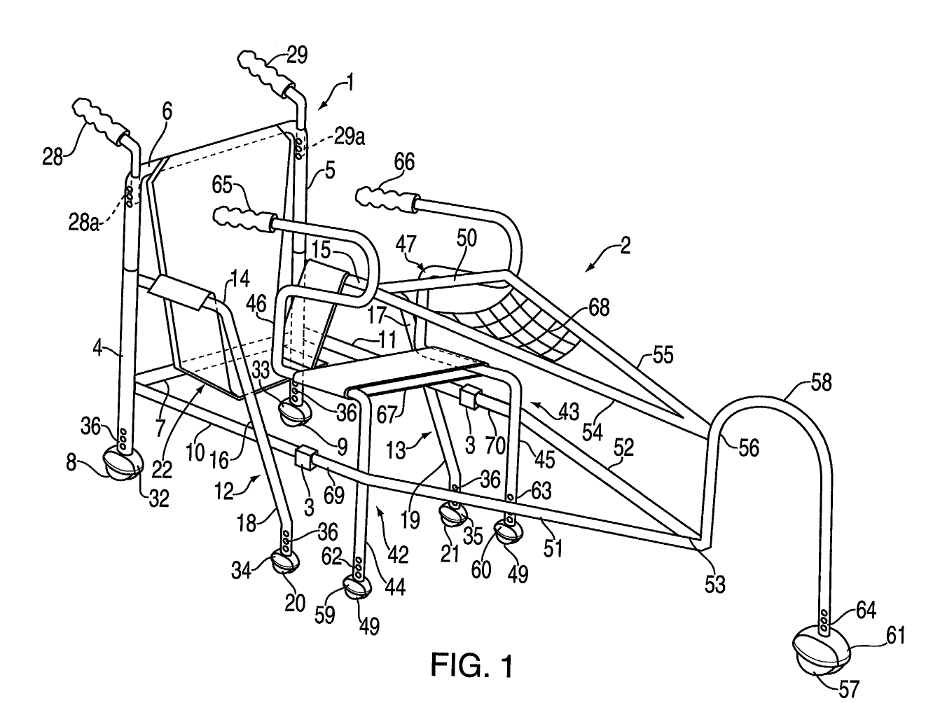

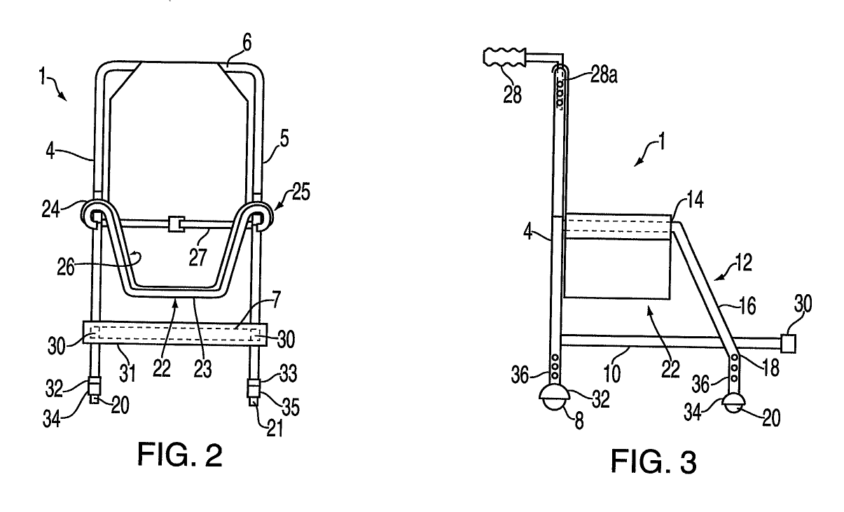

Referring to FIG. 1, the ambulation device for physically challenged persons is shown to include an ambulatory chair 1 movable by feet of an occupant of the chair 1, a tripod walker 2 and a connection means 3 to selectively connect the ambulatory chair 1 to the tripod walker 2 to provide an integral unit as shown in FIG. 1 and to selectively disconnect the ambulatory chair 1 from the tripod walker 2 as shown in FIGS. 2 and 5 to enable separate and independent use of the chair 1 and the walker 2 depending upon the desires of the chair occupant and a care giver.

Referring to FIGS. 1-4, the ambulatory chair 1 includes a first pair of members 4 and 5 substantially parallel to each other, spaced from each other and upright. A first member 6 substantially perpendicular to and connected between the first pair of members 4 and 5 adjacent one end thereof and a second member 7 substantially perpendicular to and connected between the members 4 and 5 at a first point disposed between the one end and the other end of the members 4 and 5. A first pair of wheels 8 and 9 having a first predetermined diameter are connected to the other end of a different one of the first pair of members 4 and 5.

A second pair of members 10 and 11 are substantially parallel to and spaced from each other with each of these members 10 and 11 being substantially perpendicular to a different one of the first pair of members 4 and 5 and connected thereto adjacent the second member 7. A third pair of members 12 and 13, substantially parallel to and spaced from each other, each having a first portion 14 and 15 substantially parallel with an associated one of the second pair of members 10 and 11 substantially perpendicular to an associated one of the first pair of members 4 and 5 and connected to an associated one of the first pair of members 4 and 5 at a second point different than the first point between the first member and the second member, a second portion 16 and 17 extending at given angle from an end of the first portion 14 and 15 spaced from the associated one of the first pair of members 4 and 5 to a third point on the associated one of the second pair of members 10 and 11 in a predetermined spaced relationship with an end of the associated one of the second pair of members 10 and 11 remote from the associated one of the first pair of members 4 and 5 and a third portion 18 and 19 extending below the associated one of the second pair of members 10 and 11 from the third point at an angle predeterminedly related to the given angle. A second pair of wheels 20 and 21 having a second predetermined diameter predeterminedly less than the first predetermined diameter are connected to an end of the third portion 18 and 19 of the third pair of members 12 and 13 remote from the third point and a seat 22 for the occupant secured to the first member 6 and the first portion 14 and 15 of each of the third members 12 and 13.

The seat 22 includes a gel foam seat 23 to conform to the occupant's body to prevent pressure sores, a pair of molded arm rests 24 and 25 each disposed on a different one of a first portion 14 and 15 of the third pair of members 12 and 13 to prevent sores on the arms of the occupant and for ease of transfer of the occupant from a bed or a chair or the like to the ambulatory chair 1 from the side without removing arms 24 and 25 and a water impermeable and washable cover 26 to cover the gel foam seat 23 and the pair of molded arm rests 24 and 25.

The ambulatory chair further includes a seat belt 27, best shown in FIG. 2, for safety of the occupant and to provide a counterforce for ambulation when the occupant moves the chair by his or her feet.

A pair of ergonomic handles 28 and 29 are each telescoped into a different one of the first pair of members 4 and 5 adjacent the first member 6 to enable a care giver to push the ambulatory chair 1. Handles 28 and 29 are molded to conform to deformities and arthritic conditions of the hands of the care giver and are adjustable as to height of the handles and rotatable for orientation of handles 28 and 29 relative to the back of the chair by means of rotational and detent means 28a and 29a in members 4 and 5.

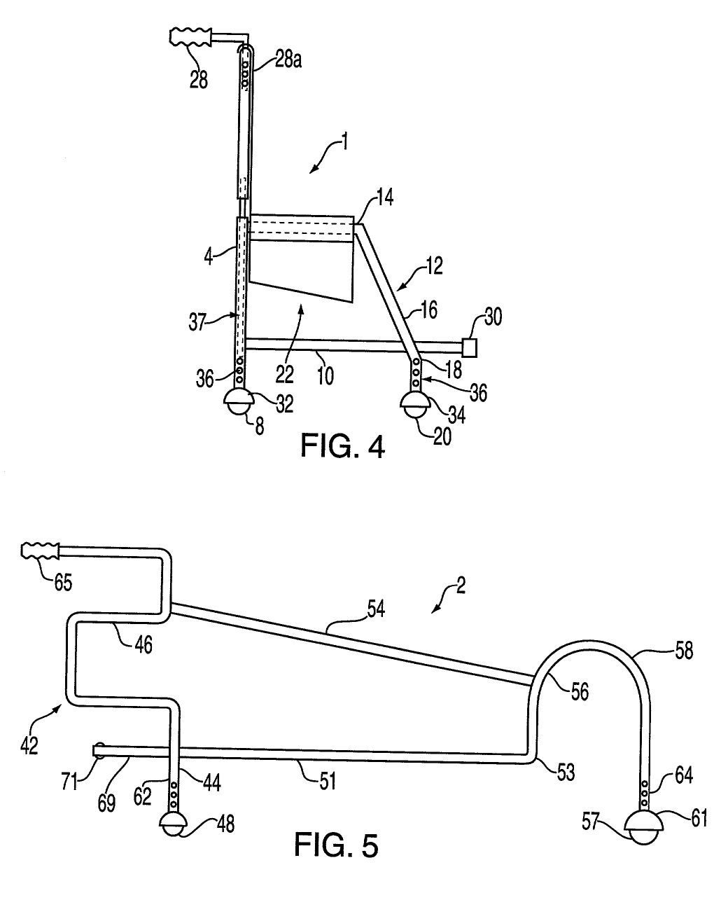

A component 30 of the connection means 3 is connected to each end of the second pair of members 10 and 11 remote from the first pair of members 4 and 5, as best seen in FIGS. 3 and 4. When the ambulatory chair 1 is disconnected from the tripod walker 2, a foot rest 31 for the occupant can be selectively connected to the first component 30 of the connecting means 3 when the ambulatory chair is used separately.

The pair of wheels 8 and 9 and the pair of wheels 20 and 21 are free to swivel 360° when the occupant is seated in the seat 22 and includes fenders 32 and 33 covering wheels 8 and 9 and fenders 34 and 35 covering wheels 20 and 21 to prevent injury to the occupant by catching their fingers in the wheels 8, 9, 20 and 21.

The ambulatory chair I further includes a height adjustment 36 for each of the wheels 8, 9, 20 and 21. Height adjustment is shown to be of the snap-in spring loaded hole type.

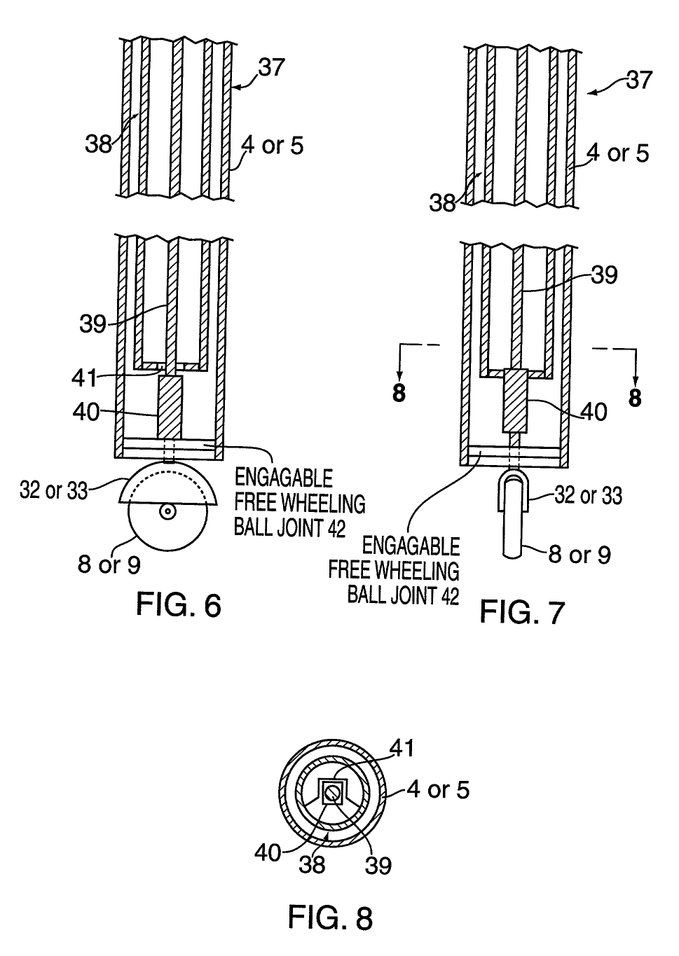

Ambulatory chair 1 further includes a system 37 in each of the first pair of members 4 and 5, shown in detail in FIGS. 6-8, to assist the occupant in raising from the seat 22 by raising the seat 22 and simultaneously locking the first pair of wheels 8 and 9 in a front to back orientation when seat 22 is fully raised as indicated in FIG. 4.

When the occupant is seated, the hydraulic system 37 including cylinder 38 and piston 39 disengages the member 40 from the locking arrangement 41 and engages the free wheeling ball joint 42 to enable the wheels 8 and 9 to freely rotate 360°.

Referring to FIGS. 7 and 8, the location of the member relative to member 41 is shown in detail and occurs when the occupant of the chair 1 raises into a standing position and the seat 22 is tipped upwardly so as to assist the occupant in raising. When this occurs member 40 engages locking device 41 and cause the wheels 8 and 9 to be oriented in the front to back position. FIGS. 6, 7 and 8 illustrate one of the systems that can be used for systems 37 to raise the seat 22 and to assist the occupant in raising and to lock the wheels 8 and 9 in the front to back orientation. Other known systems are available to accomplish the same result.

Referring to FIGS. 1 and 5, the tripod walker 2 includes a pair of members 42 and 43 having an upright portion 44 and 45 and a S-shaped portion 46 and 47 having one end there connected to the upright portion 44 and 45, respectively. A pair of wheels 48 and 49 having a diameter equal to the diameter of wheels 20 and 21 are connected to the other end of the upright portions 44 and 45. A stabilizing member 50 is connected between the S-shaped portions 46 and 47 as best illustrated in FIG. 1 and a pair of members 51 and 52 are each connected to a different one of the upright portions 44 and 45 intermediate one end and the other end of the upright portion 44 and 45 extending forward therefrom and converging at a predetermined point 53 remote from members 42 and 43. A pair of members 54 and 55 are each connected to a different one of the S-shaped portions 46 and 47 extending forward therefrom and converging at a second predetermined point 56 remote from the members 42 and 43 spaced from the first point 53. A single wheel 57 having a diameter equal to the diameter of wheels 8 and 9 are spaced from the first and second points 53 and 56 and a gooseneck-like connecting member 58 is connected between wheel 57 and members 51 and 52 and 54 and 55 at points 53 and 56. The wheels 48 and 49 have fenders 59 and 60 while wheel 57 has a fender 61 again to protect the occupant of the chair from injuries which might result from catching fingers in the wheels 48, 49 and 57.

Wheels 48 and 49 as well as wheel 57 include height adjusting mechanism 62, 63 and 64 of the snap-in spring loaded hole type to enable adjusting the height of the walker 2 for the convenience of the occupant. When the chair 1 and the walker 2 are an integral unit as shown in FIG. 1, the height adjustments 36, 62, 63, and 64 would be coordinated to ensure the integral unit is level and comfortable for the occupant. The wheels 48 and 49 as well as wheel 57 are swivable 360° at all times.

A pair of ergonomic handles 65 and 66 are each disposed at the end of a different one of the S-shaped portions 46 and 47 with each of the handles 65 and 66 being molded to conform to the deformities or arthritic conditions of the occupant.

A food and activity tray 67 for the occupant is removably secured to the S-shaped portion of both the members 42 and 43 when the tripod walker and the ambulatory chair are connected together in an integral unit.

A means 68, such as a net or a basket, can be suspended between the members 54 and 55 to carry personal items and the like of the occupant, or the items bought shopping.

A pair of members 69 and 70 substantially parallel with respect to each other has one end connected to a different one of the upright portion 44 and 45 in a predetermined relationship with the pair of members 10 and 11. A component 71 of the connection means 3 is connected to the other end of the members 69 and 70. Connection means 3 contains hole along its length which spring loaded component 71 will engage to provide the connection between the chair and walker 2. This is the same type of mechanism for the height adjustment of wheels 8, 9, 20, 21, 49 and 57.

When the chair 1 and walker 2 are separated the ends 30 and 71 of the chair and walker are covered by a protective cap to prevent injury to the occupant. Seat 22 is a gel, silicon type pillow covering the entire aluminum or fiber filled structure. Seat 22 has a gel quality with specifications for creep and rebound and covered with a foam for comfort and long term sitting. Seat 22 covers the back, bottom as well as the arm rests 24 and 25 to minimize pressure sores to the bony prominences of the sacrum, ilium and the bony prominences of the elbows, wrists and the scapula. These seats and covers will conform to the variety of shapes and sizes of individuals' spines and buttocks areas as well as the bony prominences. Foam 23 will be covered by a fabric 26 that is water impermeable, color coordinated, washable fabric to enable cleaning up food, defecation or urine soiling and to allow disinfectant to be used to prevent reinfection or contamination of the patient. The arms 24 and 25 of the seat 22 are curved and constructed for the ease of sideward motion or transfer entry to the chair 1 allowing the user to slide from a bed or a chair to the chair 1 using the arms to slide downward and into the padded cushion. The front end of the arms 24 and 25 in section 16 are used as grips for steering while in the ambulatory mode.

The seat belt 27 is for safety and either attached by VELCRO, a hook and loop fastener, or seat belt clips to prevent the patient from falling from the chair and affords them the use of the abdominal strap for the counter resistance necessary for forward motion while seated allowing the forward pressure on the strap and the propulsion of the legs to propel the vehicle forward as it attaches to the torso. The chair 1 is specifically designed for the provision of ease of mobility while in the seated position. This also affords the patient potential for physical therapy, the therapeutic use of the muscles for ambulation and strengthening. This is enhanced by the ambulation exercise and rehabilitation by the establishment of a very low center of gravity with the low center of gravity having two purposes. First, it provides the physically challenged person whose long muscles have atrophied, or been affected by stroke to force the utilization of the pelvic girdle muscles to propel themselves forward. If the patient can sustain themselves in a sitting position and can move their thighs, the chairs free wheeling mechanism can be propelled easily in all directions forward, backward, sideward and diagonally while in the chair portion of the device. Utilization of the chair device can be to rehabilitate stroke, or unilaterally neurologically impaired individuals and provide a way for normally bed ridden relegated patients to gain independence. Secondly, the low center of gravity provides more stability making it more difficult for the patient to tip the device over or be tipped over as it crosses different textured floors, thresholds, carpeting etc.

Another feature of the chair is its ability to raise and lower to the occasion of the physically challenged persons having difficulty standing or sitting in a low position. This problem is addressed with the unique design of the hydraulic system 37 which raises and lowers the seat and moves the wheels 8 and 9 from a stable front to back direction in a locked position to a freewheeling multidirectional mode.

The wheels 8, 9, 20 and 21 must be of the lowest coefficient of friction with the back wheels 8 and 9 being approximately 6″ in diameter and the front wheels 20 and 21 being approximately 3″ in diameter. The wheels are attached to a shaft which fits into tube, the shaft having an adjustable snap-in spring loaded hole mechanism with holes set approximately 1″ apart up the tube to adjust for the height of the patient.

The internal mechanism of the wheels will be such that with the full weight of the patient distributed in the chair, hydraulic arrangement 37 placed inside the tubes 4 and 5 will gently lower the posterior wheels and the patient to a low center of gravity and disengage wheels 8 and 9 from a locked parallel, posterior direction to a freewheeling position enabling the chair to move in any and all directions. This free wheeling position, low center of gravity allows the patient more range of mobility unattainable by any other device on the market including a turning radius equivalent to its greatest diagonal diameter. The patient can in effect stay in one place and spin 360° utilizing less space in bedrooms and nursing homes. This allows the patient to move in a crowded area with more mobility, even getting out from behind objects, tables and desks.

The wheel shaft will be centrally located on the wheel or slightly off set therefrom. The hydraulic arrangement as shown in FIGS. 6-8 will enable engaging the free wheeling mechanism 42 by the downward motion of 39 and, hence, 40, caused by the weight of the occupant in the chair 1 as shown in FIG. 6. As the patient sits the hydraulic piston 39 will have a specific range of motion. The hydraulic system 37 will also provide the second function when the patient stands. As the patient lifts his full weight from the seat the piston 39 of the system 37 will slowly resume its normally extended position as shown in FIG. 7, similar to hydraulics on a lift gate on a van or the like. Member 40 engages locking arrangement 41 as shown in FIG. 8 as soon as the patient raises from the chair. In this position the wheels 8 and 9 will lock in the unidirectional position allowing chair 1 to move in only a parallel, forward and backward direction. This assists the patient into the raised position and locks the direction of the wheels 8 and 9 into a parallel unidirectional position. This is of extreme importance to the safety of the occupant. Providing the occupant with the stability necessary to post against and not allowing the chair to move laterally and remains fixed behind the patient in the event of necessity for immediate reentering the chair when the chair 1 and the walker 2 are an integral unit. A brake system is provided on the wheels to prevent the chair 1 and tripod 2 from moving is important for the transfer of the occupant to a toilet or chair or stationary bed.

With the patient standing, the arrangement 37 is fully extended which elevates the patient and the seat maintaining the seat in the fully up position locking the wheels 8 and 9 and elevating and canting the seat 22 slightly forward for better reentry. The wheels 8, 9, 20 and 21 are provided with cantilever fenders 32, 33, 34 and 35 for the prevention of the occupant from placing dangling fingers, arms or clothing in the moving parts. These fenders will also prevent splashing while moving through spilled liquids, or standing water. The wheel system of chair 1 will have the standard brake device to prevent rolling downhill operated from the position of the seat itself.

The walker 2 is designed to be a more stable, more functional and unique design than is any existent on the market. The variation of the tripod walker 2 provides a more stable posting service and minimizes the ability of lateral falling by reinforcing with lateral struts and cross bars such as bar 47 and struts 51, 52, 54 and 55. The parallel members 42 are S-shaped design which provides the patient with assistance in rising from a low center of gravity to a standing position by climbing the handle from a lower to a higher rung. This is important when used in combination with the chair to provide a surface for the auxiliary snap-in table 67. The cross bar 47 provides stability for downward pressure when the walker 2 is used independently and prevents inward collapse and diagonal falls. The cross bar 47 can also be used as a handle. Struts 51, 52, 54 and 55 attach to the gooseneck member 58 of the front axle to prevent forward tipping and forward loading of the front wheel to swing the patients forward and provide some shock absorption over irregular surfaces. The wheels 48 and 49 and 57 are respectively 3″ in diameter and 6″ in diameter.

The handles 65 and 66 are moldable soft foam, or can be custom designed to conform to the deformities of the occupant. The back wheels 48 and 49 and front wheel 57 all have 1″ adjustable heights use a snap-in spring load hole type mechanism and all have the same coefficient of frictional ball bearing mechanisms able to move in any direction.

Ambulation in walker 2 as a solitary unit provides more stabilizing forces to counterbalance the weight of the patient and the forward motion against the resistance of the floor. The walker with its two lower transverse bars 69 and 70 have male counterpart locking devices 71 which slides into a female port of device 3 of chair 1 thereby coupling chair 1 and walker 2 together by a spring locking button hole mechanism and off-set coupling device. Now the ambulation device is complete. It provides a secure contained unit which allows the patient to ambulate with the security of the seat 22 behind in case of emergency, fatigue or collapse and will have the comfort of knowing it is there. This is unique for a tripod walker as the patient has to turn around and sit down as walkers now exist. The chair 1 and walker 2 can be easily separated by pushing on the spring locking button of device 71 in device 3. Devices 71 and 3 also insure that the chair 1 and walker 2 are securely attached together. If chair 1 and walker 2 are in separate locations in the facility one can be used to get to the other and then the connection can be easily be made. The adonized aluminum structure of the chair 1 and the walker 2 is color coordinated for ease of identification.

While I have described above the principles of my invention in connection with specific apparatus, it is to be clearly understood that this description is made only by way of example and not as a limitation to the scope of my invention as set forth in the objects thereof and in the accompanying claims.

I claim:

1. An ambulation device for physically challenged persons comprising:
an ambulatory chair movable by feet of an occupant of said ambulatory chair;
a rolling tripod walker having three wheels; and
connection means to selectively connect said ambulatory chair to said rolling tripod walker to provide an integral unit and to selectively disconnect said ambulatory chair from said rolling tripod walker to enable separate and independent use of said ambulatory chair and said rolling tripod walker by the occupant.

2. An ambulation device according to claim 1, wherein
said ambulatory chair includes
a first pair of members being substantially parallel, spaced and upright,
a first member substantially perpendicular to and connected between said first pair of members adjacent one end thereof,
a second member substantially perpendicular to and connected between said first pair of members at a first point disposed between said one end and the other end of said first pair of members,
a first pair of wheels having a first predetermined diameter, each of said first pair of wheels being connected to said other end of a different one of said first pair of members,
a second pair of members being substantially parallel to and spaced from each other, each of said second pair of members being substantially perpendicular to a different one of said first pair of members and connected thereto adjacent said second member,
a third pair of members substantially parallel to and spaced from each other, each of said third pair of members having a first portion substantially parallel with an associated one of said second pair of members, substantially perpendicular to an associated one of said first pair of members and connected to said associated one of said first pair of members at a second point different than said first point between said first member and said second member, a second portion extending at a given angle from an end of said first portion spaced from said associated one of said first pair of members to a third point on said associated one of said second pair of members in a predetermined spaced relation with an end of said associated one of said second pair of members remote from said associated one of said first pair of members and a third portion extending below said associated one of said second pair of members from said third point at an angle predeterminedly related to said given angle,
a second pair of wheels having a second predetermined diameter predeterminedly less than said first predetermined diameter, each of said second pair of wheels being connected to an end of said third portion of said third pair of members remote from said third point, and
a seat for said occupant secured to said first member and said first portion of each of said third pair of members.

3. An ambulatory device according to claim 2, wherein said seat includes
a gel foam seat to prevent pressure sores,
a pair of molded arm rests each disposed on a different one of said first portion of each of said third pair of members for sore prevention and ease of transfer from a bed and the like to said ambulatory chair from the side without removing said pair of molded arm rests, and
a water impermeable and washable cover for said gel foam seat and said pair of molded armrests.

4. An ambulatory device according to claim 2, further including
a seat belt connected to said ambulatory chair for safety of said occupant and a counterforce for ambulation.

5. An ambulatory device according to claim 2, further including
a pair of ergonomic handles each connected to a different one of said first pair of members adjacent said first member to enable a care giver to push said ambulatory chair, said pair of ergonomic handles providing comfort for deformities and arthritic conditions of the hands of said care giver.

6. An ambulatory device according to claim 2, wherein
said connection means includes
a component connected to an end of each of said second pair of members remote from said first pair of members, and
said ambulatory chair further includes
a foot rest for said occupant selectively connected to said component when said ambulatory chair is used separately.

7. An ambulatory device according to claim 2, wherein
said first pair of wheels and said second pair of wheels are free to swivel 360° when said occupant is seated in said seat, said first pair of members and each of said third portion of said third pair of members includes a height adjustment to adjust the height of said ambulatory chair and including fenders covering said first pair of wheels and said second pair of wheels to prevent injury to said occupant by said first pair of wheels and said second pair of wheels, and
said ambulatory chair further includes
a system in each of said first pair of members to assist said occupant in raising from said seat by raising said seat and simultaneously locking said first pair of wheels in a front to back orientation when said seat is fully raised.

8. Am ambulatory device according for physically challenged persons comprising;
an ambulatory chair movable by feet of an occupant of said ambulatory chair;
a tripod walker; and
connection means to selectively connect to said ambulatory chair to said tripod walker to provide an integral unit and to selectively disconnect said ambulatory chair from said tripod walker to enable separate and independent use of said ambulatory chair and said tripod walker by the occupant;
said tripod walker including
a first pair of members substantially parallel with and spaced from each other, each of said first pair of members having an upright portion and a S-shaped portion having one end thereof connected to one end of said upright portion,
a pair of wheels having a first predetermined diameter, each of said pair of wheels being connected to the other end of a different one of said upright portion of said first pair of members,
a stabilizing member connected between said S-shaped portion of each of said first pair of members,
a second pair of members each connected to a different one of said upright portion of said first pair of members intermediate said one end of said other end of said upright portion extending forward therefrom and converging at a first predetermined point remote from said first pair of members,
a third pair of members each connected to a different one of said S-shaped portion of said first pair of members extending forward therefrom and converging at a second predetermined point remote from said first pair of members spaced from said first predetermined point,
a single wheel having a second predetermined diameter predeterminedly greater than said first predetermined diameter spaced from said first and second predetermined points, and
a gooseneck-shaped connecting member connected between said single wheel and said second and third pair of members at said first and second predetermined points.

9. An ambulatory device according to claim 8, wherein
said pair of wheels and said single wheel are adjustable to adjust the height of said tripod walker and capable of swiveling 360°.

10. An ambulatory device according to claim 8, further including
a pair of ergonomic handles each disposed at the other end of a different one of said S-shaped portion of said first pair of members, each of said pair of ergonomic handles providing comfort for deformities and arthritic conditions of the hands of said occupant.

11. An ambulatory device according to claim 8, further including
a food and activity tray for said occupant removably secured to said S-shaped portion of said first pair of members when said tripod walker and said ambulatory chair are said integral unit.

12. An ambulatory device according to claim 8, further including
net means suspended between said third pair of members to carry personal items of said occupant.

13. An ambulatory device according to claim 8, further including
a fourth pair of members substantially parallel with respect to each other, each of said fourth pair of members having one end connected to a different one of said upright portion of said first pair of members in a predetermined relationship with said second pair of members, and
said connection means includes
a component connected to the other end of each of said fourth pair of members.

14. An ambulatory device for physically challenged persons comprising;
an ambulatory chair movable by feet of an occupant of said ambulatory chair;
a tripod walker; and
connection means to selectively connect said ambulatory chair to said tripod walker to provide an integral unit and to selectively disconnect said ambulatory chair from said tripod walker to enable separate and independent use of said ambulatory chair and said tripod walker by the occupant;
said ambulatory chair including
a first pair of members being substantially parallel, spaced and upright,
a first member substantially perpendicular to and connected between said first pair of members adjacent one end thereof,
a second member substantially perpendicular to and connected between said first pair of members at a first point disposed between said one end and the other end of said first pair of members,
a first pair of wheels having a first predetermined diameter, each of said first pair of wheels being connected to said other end of a different one of said first pair of members,
a second pair of members being substantially parallel to and spaced from each other, each of said second pair of members being substantially perpendicular to a different one of said first pair of members and connected thereto adjacent said second member,
a third pair of members substantially parallel to and spaced from each other, each of said third pair of members having a first portion substantially parallel with an associated one of said second pair of members, substantially perpendicular to an associated one of said first pair of members and connected to said associated one of said first pair of members at a second point different than said first point between said first member and said second member, a second portion extending at a given angle from an end of said first portion spaced from said associated one of said first pair of members to a third point on said associated one of said second pair of members in a predetermined spaced relation with an end of said associated one of said second pair of members remote from said associated one of said first pair of members and a third portion extending below said associated one of said second pair of members from said third point at an angle predeterminedly related to said given angle,
a second pair of wheels having a second predetermined diameter predeterminedly less than said first predetermined diameter, each of said second pair of wheels being connected to an end of said third portion of said third pair of members remote from said third point, and
a seat for said occupant secured to said first member and said first portion of each of said third pair of members; and
said tripod walker including
a fourth pair of members substantially parallel with and spaced from each other, each of said fourth pair of members having an upright portion and a S-spaced portion having one end thereof and a S-spaced portion having one end thereof connected to one end of said upright portion,
a third pair of wheels having said second predetermined diameter, each of said third pair of wheels being connected to the other end of a different one of said upright portion of said fourth pair of members,
a stabilizing member connected between said S-shaped portion of each of said fourth pair of members,
a fifth pair of members each connected to a different one of said upright portion of said fourth pair of members intermediate said one end of said other end of said upright portion extending forward therefrom and converging at a first predetermined point remote from said fourth pair of members,
a sixth pair of members each connected to a different one of said S-shaped portion of said fourth pair of members extending forward therefrom and converging at a second predetermined point remote from said fourth pair of members spaced from said first predetermined point,
a single wheel having said first predetermined diameter spaced from said first and second predetermined points, and
a gooseneck-shaped connecting member connected between said single wheel and said fifth and sixth pair of members at said first and second predetermined points.

15. An ambulatory device according to claim 14, further including
a seventh pair of members substantially parallel with respect to each other, each of said seventh pair of members having one end connected to a different one of said upright portion of said fourth pair of members in alignment with said end of a different one of said second pair of members, and
said connecting means includes
a spring locking-hole button connector to connect said end of each of said second pair of members to an end of a corresponding one of said seventh pair of members remote from said fourth pair of members.

16. An ambulatory device according to claim 15, wherein
said seat includes
a gel foam seat to prevent pressure sores,
a pair of molded arm rests each disposed on a different one of said first portion of each of said third pair of members for sore prevention and ease of transfer from a bed and the like to said ambulatory chair, and
a water impermeable and washable cover for said gel foam seat and said pair of molded arm rests.

17. An ambulatory device according to claim 16, further including
a first pair of ergonomic handles each connected to a different one of said first pair of members adjacent said first member to enable a care giver to push said integral unit, said first pair of ergonomic handles providing comfort for deformities and arthritic conditions of the hands of said care giver, and
a second pair of ergonomic handles each disposed at the other end of a different one of said S-shaped portion of said fourth pair of members, each of said second pair of ergonomic handles providing comfort for deformities and arthritic conditions of the hands of said occupant.

18. An ambulatory device according to claim 17, further including
a food and activity tray for said occupant removably secured to said S-shaped portion of said fourth pair of members.

19. An ambulatory device according to claim 18, further including
means suspended between said sixth pair of members to carry personal items of said occupant.

20. An ambulatory device according to claim 19, wherein
said first, second and third pair of wheels and said single wheel includes
height adjusting means to enable adjusting the height of said ambulatory chair and said tripod walker, and
fenders covering said first, second and third pair of wheels and said single wheel to prevent injury to said occupant by said first, second and third pair of wheels and said single wheel, and
further including
a system in each of said first pair of members to assist said occupant in raising from said seat by raising said seat and simultaneously locking said first pair of wheels in a front to back orientation when said seat is fully raised,
each of said first, second and third pair of wheels and said single wheel being capable of swiveling 360°, said first pair of wheels being prevented from swiveling when said seat is fully raised.
